(19) United States
(12) Patent Application Publication
(10) Pub. No.: US 2002/0147043 A1
(43) Pub. Date: Oct. 10, 2002

(54) Computer network implemented casino marketing system

(76) Inventors: Barry Shulman, Las Vegas, NV (US); Michael Shulman, Las Vegas, NV (US)

Correspondence Address: Quirk & Tratos, Suite 500 North, 3773 Howard Hughes Parkway, Las Vegas, NV, 89109, US

(21) Appl. No.: 09/829,504

(22) Filed: Apr. 9, 2001

(51) Int. Cl. G06F 17/00

(52) U.S. Cl. 463/42

(57) ABSTRACT

A method inviting members of the public to participate in various free, computer network implemented gaming events awards prizes to those participants that have obtained some predetermined ranking in the event. The method divides eligibility criteria in each gaming even in accordance with a plurality of intersecting and non-intersecting subsets of demographically significant indicia. The process of collecting the prize includes comparison of the recipient's personal data against the particular subset, thus insuring a highly reliable data base in each of the subsets. In this manner accurate data is collected that may be useful in marketing endeavors.

### BACKGROUND OF THE INVENTION

1. Field of the Invention

The present invention relates to computer network information management, and more particularly to a method for garnering the attention of those network users that are proficient in various gaming endeavors.

2. Description of the Prior Art

Those engaged in the front lines of marketing are well informed of the difficulties in garnering the attention of any potential customer. While a salesman's persistence is legendary, and has even motivated some great literary works, this undying persistence stems from the unfocused nature of any initial sales contact which stands at the threshold of all marketing efforts. Simply, one initially has no clue at all of the potential recipient's predispositions, propensity to purchase, and even the facility to comprehend the salesman's salutations. Rejection, therefore, is rationally anticipated and this anticipation sets the tenor for all the introductory discourse that follows.

Recently, mass acceptance of computer aided communication has fundamentally changed this selling task. At the core is the on-off nature of the communication, where the first threshold level is expressed directly by the participant as he or she ‘log on.’ Whether in its current form known generally as the “Internet” or in any of its specialized forms like some Local Area Network [LAN], Wide Area Network [WAN], all network communication requires an affirmative act, i.e., one has to want to communicate. Those instances of rejection that are associated with a plain desire to be left alone, therefore, drop out of the equation.

Moreover, the communication mechanism allows broadcasting to more than one recipient and has been therefore rendered impersonal. Accordingly, rejection is no longer something that can be associated with one's personal attribute and is simply an economic matter. Broadcasting is associated with cost and optimized mechanisms for selecting the potential audience have therefore proliferated in the art. Along with these audience targeting methods also came various techniques for garnering the attention of those selected to receive the broadcast.

Examples of such attention garnering techniques can be found in the teachings of U.S. Pat. No. 5,794,210 to Goldhaber et al., U.S. Pat. Nos. 5,823,879 and 6,183,366 to Goldberg et al., and others. Examples for selecting the potential audience, in turn, can be found in the targeting technique taught in U.S. Pat. No. 6,119,098 to Guyot et al., U.S. Pat. No. 6,115,709 to Gilmour et al., and others. Each of the foregoing, while suitable for the purposes intended, describes methods and processes that follow separate paths in the targeting and then in the attention garnering. Simply, attention garnering is treated separately from the audience selection process.

The organic progression of any market system, however, does not follow these orthogonal paths. Instead, symbiotic common interest pools form the primary mechanisms for any eventual market structure. These common interests are both fundamental (genetic) and those induced by habituation, and their lines of force then define the eventual contours of the specific market. A system that optimizes this manner of market formation is therefore desired.

Associated with the development of computer aided communication is also a profound increase in labor productivity. These efficiencies and the resulting accumulation of wealth have fueled markets that are focused on leisure and prominent amongst these is the casino gaming market. This market includes at its center the compelling and entertaining attributes of a game of chance, and is therefore driven by both the consumer and the provider forces. A system that optimizes the market formation as result of these interlaced forces is extensively sought and it is one such technique that is disclosed herein.

### SUMMARY OF THE INVENTION

Accordingly, it is the general purpose and object of the present invention to provide a computer network based communication system that awards to the users thereof redeemable credits based on each user's facility and interest in casino games.

Other objects of the invention are to provide a method for selecting potential casino patrons on the bases of their interest and facility in network based gratuitous gaming contests.

Yet further objects of the invention are to provide a method for attracting the attention of potential business patrons based on their pre-existing preferences.

Briefly, these and other objects are accomplished within the present invention by way of a computer network implemented information base that provides wholly unrestricted access to all those on the network that are interested in participating as competitors on a variety of casino games. In each instance access to such competition is wholly unrestricted, without any cost or condition to the entrant, nor is there any future obligation suggested or required. In this manner all the most rigorous local prohibitions against gambling are observed with all proper deference and left unoffended. In the course of this competition each participant is ranked against others, within narrowly defined demographic classifications, earning a bonus and even a designation like “master,” “champion” or “contender.” Thus each contestant can seek to gain a plurality of rankings, within a whole variety of class intervals of demographically significant personal data, defined by one or another rubric of participation. Of course, such multiple participation also obtains for the game conductor a large amount of personal data that is voluntarily disclosed.

For example one ranking index may be based on an age bracket, another based on culinary taste groupings, the third on language preference, and so on. In each instance the graduated ranking level may then be used to obtain certain seating, lodging or dining preferences at subscribing casinos.

One will note that this methodology obtains all sorts of demographically significant information on each contestant. More importantly, this information is obtained by self-reporting, without the usually offending notions of prying or invasion of privacy concerns. Moreover, this information is coupled with the obvious measure of efficacy, as the data is eventually verified at the time when the bonus points or rankings are claimed. Of course, the data is also informative of contestant's proficiency and gaming preference.

As a result a database is established that includes only those aspects of the contestants person that he or she wishes to report along with the contestants proficiency and preference in the various forms of casino gaming. This database, clearly, is of substantial interest to the various casinos, including those that may display their advertising banners directly on the screen on which one or another gaming contest takes place. The contestant may therefore test in the course of obtaining a ranking the benefits that the advertising casino may accord to the particular ranking levels by simply “clicking on,” or connecting to the casino information base. Of course these benefits would be eventually obtainable only upon proper identity confirmation, thereby assuring efficacy in the database.

In more detail, each contestant would first register his or her identity and in the course of such registration obtain a uniquely identifiable player number. Thereafter the player would “log on” to the particular “web pages” that carry the contest of his or her interest, e.g., “stud poker, 25-35 age bracket” and upon logging on would obtain, without any payment or condition, his or her initial “stake.” This stake would be useful only within this particular contest rubric. Using the player number the participant would then periodically elect to participate in the games by way of the network and in each instance the player's “stake,” as diminished by any losses or increased by winnings, determines the player's ranking. It will be appreciated that the probabilities of obtaining a higher ranking increase with the number of different contest rubrics that the player elects to participate in. Thus the player may also elect to enter other contest rubrics like “stud poker—practicing physicians,” and others, obtaining the initial stake for each contest class. In the course of this process most of the demographically significant data is collected. The advertising casinos can then direct their advertising on the foregoing databases and may even arrange for a credit line and limit directly on the network.

Along with the ranking information the points earned by the player may also be redeemable in exchange for some benefit at the casino. There is therefore further advantage in multiplying the number of categories in which one may participate, and in this manner expand the data base of his or her person. This data base is then of further use to the casino for refining its targeting of marketing efforts, including the accommodation of credit lines. This combination of a credit line, player identification number and the personal detail obtained by the foregoing method facilitates player tracking, further improving the database on each customer.

As a further part of this process the player identification number can be utilized to gain access to various informational databases dealing with other gaming interests and may even be useful in gaining access to other specialized competitive events that may be hosted in this system. The resulting combination of this well-developed participating client database and a web site that continuously culls, by the dominant interests, further prospective clients to the same or even greater level of detail provide a commercially viable hosting platform for casinos and other commercial entities. Simply, the resulting efficacy of the customer data is such that large premiums can be obtained from any advertiser that may want to be associated with the inventive process.

### BRIEF DESCRIPTION OF THE DRAWINGS

FIG. 1 is a diagrammatic illustration of a computer communication network organized to effect the inventive process described herein;

FIG. 2 is a sequence diagram, in the general form of a flowchart, illustrating the sequence of steps effected in the course of the present invention;

FIG. 3 is a further diagrammatic illustration of the signal flow associated with the network shown in FIG. 1; and

FIG. 4 is a graphic illustration of a population density distribution against various demographic indices useful with the present invention.

### DESCRIPTION OF THE PREFERRED EMBODIMENT

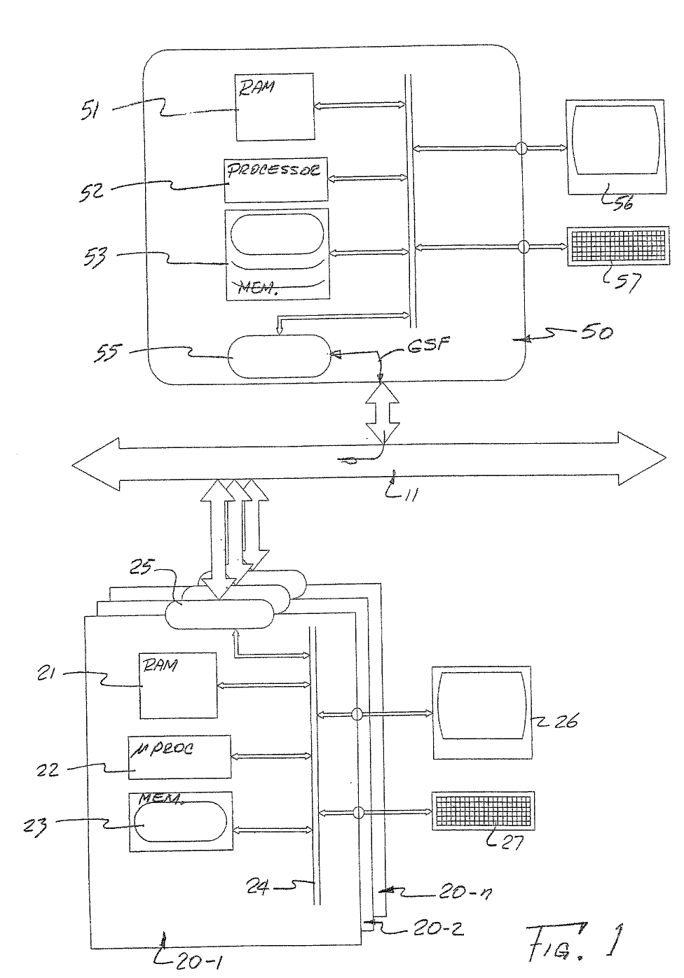

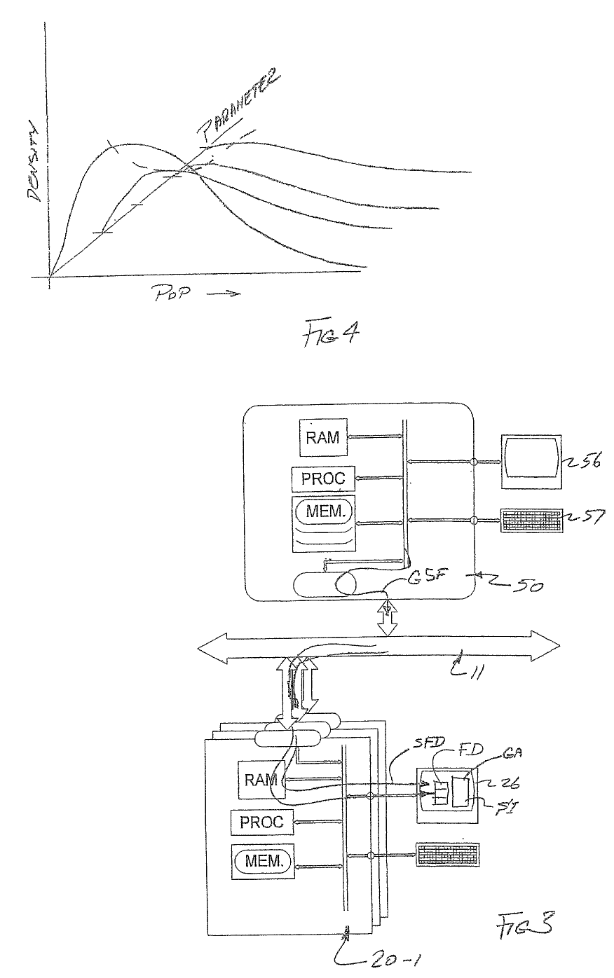

As shown in FIGS. 1-4 a computer assisted communication system, generally designated by the numeral 10, comprises a communication network 11 to which a plurality of user devices 20-1, 20-2 through 20-n are connected. In conventional practice each one of the using devices 20-1-20-n may take the form of a data processing system including a temporary memory or RAM 21, a processor 22, a permanent storage 23 illustrated as a disc under current practice, a bus 24 connecting all the foregoing to each other and to an interface 25 communicating with the network. Also included with each of the user facilities 20-1 through 20-n is an external monitor 26 and a manual entry device like a keyboard 27.

Those skilled in the art will appreciate that although each of the user facilities obtains an identical description in these teachings, in actual practice such may be variously effected. At the core is the basic architecture of all data processing systems in which some permanent storage is required, shown herein as a disc file but which may be variously implemented with devices like a read-only-memory ROM or even discrete logic combinations, a logical processor executing command sequences either from the permanent storage or developed by logical combinations that require temporary storage that may be implemented by known combinations of shift registers, latches and the like, and the temporary storage which again is illustrated by way of a RAM but which is variously devised in the art.

Consistent further with the prevailing practice, in each of the various forms the video and manual interface, illustrated herein as monitor 26 and keyboard 27, are devices implemented by the known techniques utilizing a cathode ray tube and at least some limited keypad through which the user can communicate choices and commands. Accordingly, the user's interface may take the form of other well-known and familiar structures, including the various configurations of a television set that may be remotely controlled by one or another wireless device.

The control of the various gaming contests and the associated data storage is equally effected by way of well-known systems and devices. Thus a dedicated main processing system, generally designated at 50, includes its own processor 52, a temporary working memory or RAM 51, a bus 54 and a permanent storage that may be implemented as a multiple disc array 53. In this form the main processing system duplicates in many respects the functions of what is commonly referred to as a server, including the necessary interface 55 with network 11 which, of course, will be selected to accommodate the anticipated communication volume from the various contestants.

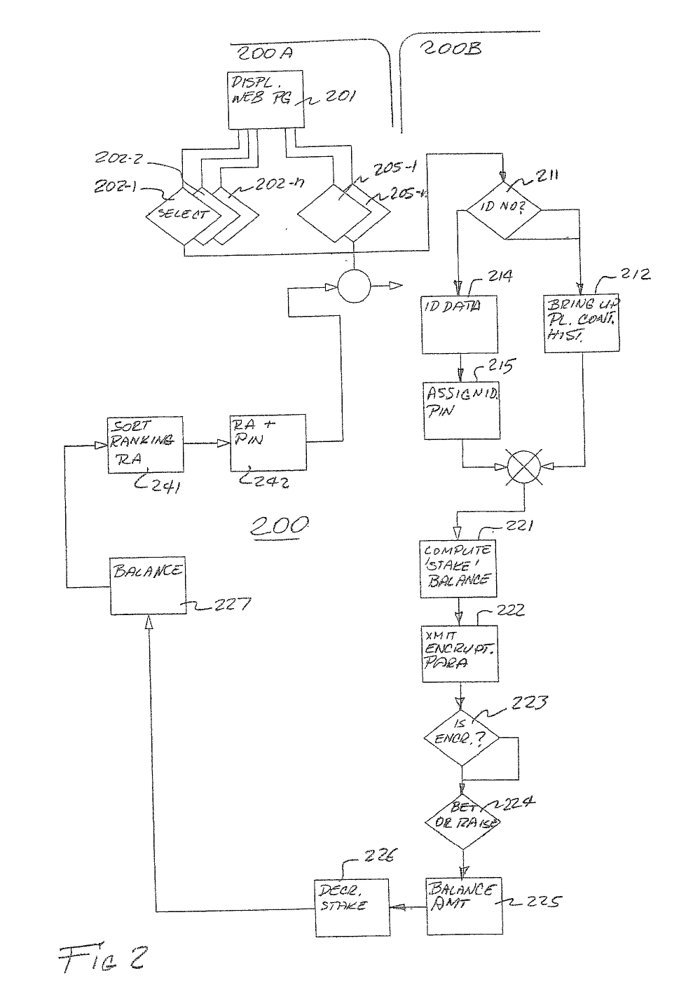

By particular reference to FIG. 2, the main processing system may include resident on its disc storage 53 a sequence of operations, shown generally as the process 200, which effects the several contests hereinabove summarized, sorts and manages the resulting demographic data collected and provides the necessary linking to such of the advertisers' sites as may be selected by any one user. Within the foregoing functions the contest process obtains the primary focus of this disclosure, as the linking and data sorting processes are known.

More precisely, the process 200 includes in a portion thereof designated as portion 200A the sequence of steps entailed in communicating the images of a web site by way of the network 11. Those in the art will appreciate that the instruction set associated with displaying a web site is well understood, usually implemented in one of the well-known languages like the Hyper-Text Markup Language HTML that interfaces with the several forms of browsers typically imbedded in the network access systems used by the using devices 20-1 through 20-n. Accordingly, this well-known process is only generally illustrated by step 201 in which the web site contents are communicated to the network 11 in a known manner, including such selection options as may allow the user to select participation in the several gaming contests shown by way of parallel branching steps 202-1 through 202-n.

Once the selection is made, by any conventional manner like clicking a mouse, the remaining game process is then invoked in accordance with the sequence illustrated in portion 200B. More precisely, in step 211 the sequence interrogates the prospective player if he or she have been earlier assigned a Player Identification Number PIN and, if so, the next step 212 then brings up from memory the players prior contest history including any prior participation in the particular game rubric selected. If not, the player is asked to provide personal identification data in step 214 in sufficient detail to meet the various qualifying indices of the selected game rubric. Thereafter in step 215 a PIN number is assigned to this player along with the initial ‘stake’ ST-1 in the particular game rubric selected by the branching step 202-1.

At this point the player is eligible to participate in a card game contest carried on the network in the manner similar to that earlier described in the concurrently pending U.S. patent application Ser. No. 09/797,767 entitled COMPUTER ASSISTED POKER TOURNAMENT, filed on Mar. 1, 2001 by the instant co-inventor Barry Shulman, which is incorporated herein by reference. While such reference is invited a brief summary of a relevant portion of this earlier application is nonetheless repeated herein, in the interest of a complete description, it being understood that this summary and synthesis are solely in the interest of the completeness of the instant disclosure and is not intended to imply or suggest any limitation of whatever nature relating to said earlier application.

Similar to the process earlier described, once the player is provided with a player identification number and then elects to enter the selected game the demands of the subsequent information exchanges will of necessity entail security measures such as encryption and/or entry code assignment. These, of course, are under the direction of the main processing facility 50 which in step 221 effects the generally well-known process of debiting and crediting transactions associated with the player's ‘stake.’ Once this step is satisfied in step 222 an encryption algorithms and other assigned identification parameters are transferred to the requesting user station 20-1. The user is thus qualified to select any virtual card ‘table’ that has a vacancy and thereby enters the game. Having made the selection the user's next betting instruction is tested in step 223 for the necessary encryption and identification details. When these are matched the bet or raise is determined in step 224 and in step 225 the bet amount is tested against the purse still held by the user and if the remainder is sufficient the last bet LB is effected along with the decrementing of the stake amount stored in step 226. This amount may be adjusted in step 227 by any winnings and the resulting amount is compared on a continuing basis with the winnings held by others.

As this process is occurring the face down card data is also transferred to the player's facility 20-1 to be displayed as and overlay FD on the video monitor 26. More precisely, this signal from the central station, shown as signal SFD, is encrypted with the same algorithms as those transferred in step 222 to the user's facility 20-1. Accordingly, the general signal flow GSF from the central station 50 also includes this signal SFD which is passed by the locally resident encryption filters like those effected in step 223. Thus the screen image Si in the user's facility will include the generally available data GA comprising the players PL, their remaining purses PU, the face up cards FU, if any, but in this instance also including the face down card data FD. All other observers 20-2 through 20-n lack the specifics of the encryption to capture this data. In this manner the player can make whatever discard elections are needed along with the betting elections necessary for the particular game and at any desired time may simply log off the network.

During the course of the foregoing process, or on an intermittent basis, the player's purse PU, or remaining stake, is sorted in a rank ordered stack 241 in order to obtain a ranking RA. This ranking may then be combined with the player's PIN in step 242 and communicated to the subscribing casino selected by the player by way of the banner selection branchings 205-1 through 205-n.

Thus the player, in steps 205-1 through 205-n exhibits to the selected casinos all of his or her rankings and in the course thereof discloses all such personal data that may be associated therewith. Based on the casino's customer preference, these rankings may be weighted in step 207 to favor those customers that are more likely to find the casino to their taste. For example, a casino that is well equipped to serve guests in family groups may elect to favor the rankings earned in the subgroup ‘stud poker—head of household—29 to 49’ by doubling or tripling in step 207 the ranking levels in this category that will receive bonus rewards. Thus a two-way process effecting an intersection of the common tastes and preferences is provided, insuring an optimized selection by both sides.

Accordingly, a method is devised which avoids all the offensive aspects of information gathering set in an entertaining format which then extends to the entertainment elections in the casino. Clearly, those obtaining high rankings in ‘stud poker’ or ‘black jack’ will want to test these rankings in a live setting.

It will be appreciated that the foregoing process is further assured commercial viability by the revenues that can be realized from those that are not casinos but who still would want access to the very detailed potential customer data obtained herein. Thus those that may want to direct their advertising efforts to particular demographic groupings will find the data detail obtained by this process particularly useful and economically worthwhile. Moreover, the instant process provides a common interest platform for other, similarly directed enterprises both within the US and abroad assuring commercial viability.

Further commercial viability is assured by advertising revenues obtained from those that may simply want to utilize the inventive method as a vehicle for drawing public attention to their advertisements, and may include hosting of various special interest publications. In this manner all the advantages of the compelling and interest evoking attributes of card games are utilized without the attendant detriments associated therewith.

Obviously, many modifications and variations can be effected without departing from the spirit of the invention instantly disclosed. It is therefore intended that the scope of the invention be determined solely by the claims appended hereto.

It is claimed:

1. A method for engaging in a selected one of a plurality of computer network enabled contests, each said contest comprising a sequence of card games communicated on said network and conformed for participation by contestants of a unique set of demographic indicia, comprising the steps of:
selecting a contest from amongst of a plurality of said contests communicated on said network that corresponds in said demographic indicia with the attributes of the selecting contestant;
crediting said selecting contestant with a predetermined amount of initial contest credit points upon the selection of said contest;
adjusting the credit points held by said selecting contestant by any credit points that may have been won or lost by said contestant in the course of participating with others in each said individual games comprising said selected contest;
comparing the credit points held by said selecting contestant against the credit points held by others participating in said selected contest to provide a comparative ranking;
communicating said comparative ranking to a selected advertiser on said network;
verifying the personal data of said selecting contestant against said unique set of demographic indicia; and
awarding a prize by said advertiser if said contestant's personal data is consistent with said unique set of demographic indicia and said comparative ranking is of a preselected level.

2. A method according to claim 1, comprising the further step of:
displaying a plurality of advertisers on said network including said selected advertiser.

3. A method according to claim 2, comprising the further step of:
selecting from said displayed advertisers said selected advertiser.

4. A method according to claim 3, wherein:
said step of selecting a contest is effected by each said contestant that is participating in said selected contest.

5. A method for engaging in a selected one of a plurality of computer network enabled contests, each said contest being conformed for participation by contestants of a unique set of demographic indicia, comprising the steps of:
selecting a contest from amongst of a plurality of said contests communicated on said network that corresponds in said demographic indicia with the attributes of the selecting contestant;
crediting said selecting contestant with a predetermined amount of initial contest credit points;
increasing the credit points held by said selecting contestant by any credit points that may have been won by said contestant from others in the course of participating in individual games comprising said selected contest;
decreasing the credit points held by said selecting contestant by any credit points that may have been lost by said contestant to others in the course of participating in individual games comprising said selected contest;
comparing the credit points held by said selecting contestant against the credit points held by others participating in said selected contest to provide a comparative ranking;
displaying a plurality of advertisers on said network;
selecting from said displayed advertisers a selected advertiser; and
awarding a prize by said selected advertiser to said selected contestant if said contestant's comparative ranking is of a preselected level.

6. A method according to claim 5, comprising the further step of:
verifying the personal attributes of said selecting contestant against said unique set of demographic indicia.

7. A method according to claim 6, comprising the further step of:
accumulating the identity of each said selecting contestant in accordance with each said unique set of demographic indicia.

8. A method for engaging in a selected one of a plurality of computer network enabled contests, each said contest being conformed for participation by contestants of a unique set of demographic indicia, comprising the steps of:
selecting a contest from amongst of a plurality of said contests communicated on said network that corresponds in said demographic indicia with the attributes of the selecting contestant;
crediting said selecting contestant with a predetermined amount of initial contest credit points;
adjusting the credit points held by said selecting contestant by any credit points that may have been won or lost by said contestant in the course of participating with others in individual games comprising said selected contest;
comparing the credit points held by said selecting contestant against the credit points held by others participating in said selected contest to provide a comparative ranking;
displaying a plurality of advertisers on said network;
selecting from said displayed advertisers a selected advertiser;
communicating said comparative ranking to said selected advertiser on said network; and
awarding a prize by said advertiser if said contestant's comparative ranking is of a preselected level.

9. A method according to claim 8, comprising the further step of:
verifying the personal attributes of said selecting contestant against said unique set of demographic indicia.

10. A method according to claim 9, comprising the further step of:
accumulating the identity of each said selecting contestant in accordance with each said unique set of demographic indicia.

11. A method according to claim 10, wherein:
said step of awarding is conditional upon the completion of the step of verifying.

12. A method for developing an accurate data base of prospective customers in accordance with a plurality of subsets of demographically significant indicia comprising the steps of:
publishing on a computer network a plurality of first gaming contests each respectively available to potential participants in a corresponding plurality of selected demographic groupings defined by a first subset of said demographic indicia;
publishing on a computer network a plurality of second gaming contests each respectively available to potential participants in a corresponding plurality of selected demographic groupings defined by a second subset of said demographic indicia;
providing redeemable prizes to those electing to participate in each said gaming contest in accordance with their ranking therein:
verifying the personal data of each said participant that is eligible to receive a prize against the corresponding one of said first or second subset of said demographic indicia; and
awarding said prizes in accordance with said ranking to each said participant whose personal data is verified.

13. A method according to claim 12, wherein:
said first subset intersects said second subset.

14. A method according to claim 12, wherein:
said first subset does not intersect said second subset.

15. A method for developing an accurate data base of prospective customers in accordance with a plurality of subsets of demographically significant indicia comprising the steps of:
publishing on a computer network a plurality of first gaming contests each respectively available to potential participants in a corresponding plurality of selected demographic groupings defined by a first subset of said demographic indicia;
publishing on a computer network a plurality of second gaming contests each respectively available to potential participants in a corresponding plurality of selected demographic groupings defined by a second subset of said demographic indicia, said first subset intersecting said second subset;
publishing on a computer network a plurality of third gaming contests each respectively available to potential participants in a corresponding plurality of selected demographic groupings defined by a third subset of said demographic indicia, said third subset not intersecting said second subset;
providing redeemable prizes to those electing to participate in each said gaming contest in accordance with their ranking therein:
verifying the personal data of each said participant that is eligible to receive a prize against the corresponding one of said first or second subset of said demographic indicia; and
awarding said prizes in accordance with said ranking to each said participant whose personal data is verified.

16. A method according to claim 15, wherein:
each said contest is a computer network implemented card game tournament.

17. A method according to claim 16, wherein:
each said participant is provided an equal initial stake upon entering each said card tournament.

18. A method according to claim 17, wherein:
said card tournament includes a computer network implemented poker tournament.
